(19) United States
(12) Patent Application Publication
(10) Pub. No.: US 2010/0103547 A1
(43) Pub. Date: Apr. 29, 2010

(54) TRAILER HITCH MOUNTED ADJUSTABLE MIRROR

(76) Inventor: Albert J. ABBOTT, Yorktown, VA (US)

Correspondence Address: Kimberly A. Chasteen, PO Box 1243, Yorktown, VA, 23692, US

(21) Appl. No.: 12/196,220

(22) Filed: Aug. 21, 2008

(51) Int. Cl. B60R 1/06; G02B 7/198

(52) U.S. Cl. 359/881; 248/476

(57) ABSTRACT

An apparatus for mounting on a trailer which includes a gripping portion and a mirror to assist hitching the trailer to a towing vehicle while the driver/operator remains in the towing vehicle. The assembly comprises a removable spring loaded pair of griping plates for use with adjustable, telescopic tubular members on which is mounted an adjustable mirror mechanism.

The present application claims priority from U.S. Provisional Application Ser. No. 60/669,172, filed Aug. 21, 2007.

### BACKGROUND OF THE INVENTION

1. Field of the Invention

This invention is directed to the field of trailer mounted mirrors, more particularly to an adjustable mirror assembly for mounting to a trailer hitch to facilitate lining up the trailer hitch to a towing coupler secured to the towing vehicle.

2. Description of Related Art

The present invention relates to an improved remote trailer hitch alignment mechanism that features an adjustable mirror, a quick release mechanism and the ability to attach to varying sizes of trailers.

Many type of recreational vehicle trailers exist for towing boats, campers and other items. These trailers are hitched to towing vehicles most commonly by use of a ball and socket type hitch assembly. A hitch ball is mounted on the rear frame portion of the towing vehicle and the trailer is provided with a hitch socket for receiving the hitch ball. A problem encountered in hitching a trailer to a tow vehicle is in aligning the hitch socket with the hitch ball, particularly when a single person is attempting to complete the connection. The single person must maneuver the tow vehicle into proximity with the trailer and cannot see the connection being made between the hitch ball and hitch socket. While this activity can be simplified by using a second person outside the tow vehicle, this is not always possible and not always reliable.

To assist a driver with aligning a trailer to a tow vehicle, prior art devices rely on mirrors which are attached through various means to the trailer or the tow vehicle. These devices are generally complex and require a significant amount of time to install and remove.

U.S. Pat. No. 7,216,885 discloses a device which can be attached to the frame of a trailer for assisting in alignment of a tow vehicle with a trailer. The device relies on a screw type clamp and is time consuming to install or remove from the trailer.

U.S. Pat. No. 6,499,851 discloses a trailer back-up mirror which can be—removably attached to the frame of trailer for facilitating alignment of the hitch ball on a towing vehicle with the trailer hitch as the vehicle is backed toward the trailer, in order to couple the trailer hitch to the hitch ball. This device relies on a magnetic connection between the apparatus and the trailer which is not a reliable connection.

U.S. Pat. No. 6,446,999 discloses a trailer hitch alignment system for providing a driver of a vehicle the ability to visually align the hitch of the vehicle with the tongue of a trailer. The trailer hitch alignment system includes a hitch including a base portion and a joint member extending from the base portion. The hitch assembly further includes a set rod extending upwardly from the base portion. The set rod is positioned proximate the joint member. A mirror assembly is removably connected to the set rod. The mirror assembly includes a mirror pivotally coupled to a mirror connection frame. The mirror is pivotal about a generally horizontal axis.

U.S. Pat. No. 6,213,608 discloses a viewing mirror device to assist a vehicle driver when connecting the vehicle to a trailer. The mirror device comprises a viewing mirror, an attachment tube or channel for attaching the device to the vehicle hitch, and a mast that connects the viewing mirror to the attachment tube or channel. The position of the viewing mirror can be adjusted so that the vehicle driver can see both the vehicle hitch connection point and the trailer tongue connection point in the mirror.

U.S. Pat. No. 6,076,847 discloses a trailer hitch mechanism that includes an elongate post removably supported on a towed vehicle and extending upwardly therefrom; a traveler removably fitted to the post and movably positionable along a length thereof throughout a range of fixed, adjusted positions and including opposing arm members surrounding and gripping the post when in a relaxed state to thereby hold the traveler fixed to the post at the adjusted positions, and the arm members being structured to be urged outwardly from the relaxed state to release the grip, thereby permitting sliding movement of the traveler along the post; and a mirror device pivotally fitted to the traveler member and being angularly adjustable for positioning the mirror in a manner which presents a reflected image of a hitch component on the towed vehicle viewable by the operator in the rear view mirror of a towing vehicle, to thereby allow the operator to maneuver the towing vehicle so that a hitch component on the towing vehicle moves toward and into alignment with the hitch component on the towed vehicle, facilitating attachment thereof.

U.S. Pat. No. 5,309,289 discloses an optical target system for facilitating a vehicle operator's effecting alignment of the respective hitch assembly components of a towing vehicle and a towed vehicle. The system includes first and second targets that are removably positionable in referencing relationship to respective ones of the hitch assembly components and a viewing mirror that is removably positionable on the towed vehicle to provide the vehicle operator positioned in the towing vehicle with a reflected view of the two targets. Each of the two targets includes a longitudinal guidance element that is disposed in alignment with the longitudinal axis of its respective vehicle and a transverse guidance element that is transversely oriented to the respective longitudinal guidance element and located above the hitch assembly component to provide a visual reference to a vertical axis extending through those components.

While there are numerous prior devices know for assisting in the alignment of a trailer to a towing vehicle, none offer the ease or accuracy necessary for accomplishing the alignment. The manner by which the present invention achieves the goals hereof will become more apparent in the description which follows, especially when read in conjunction with the accompanying drawings.

An object of the present invention is to provide an alignment apparatus allowing a driver of a towing vehicle to visualize a trailer during alignment of the trailer to the towing vehicle.

An object of the present invention is to provide an alignment apparatus which is quickly and easily attached to and removed from a trailer.

Another object of the present invention is to provide an alignment apparatus which is adjustable.

Yet another object of the present invention is to provide an alignment apparatus which can be easily attached to a variety of trailers.

Finally, it is an object of the present invention to accomplish the foregoing objectives in a simple and cost effective manner.

### SUMMARY OF THE INVENTION

The present invention addresses these objects by providing a hitch assist apparatus for use with a trailer to be hitched to a towing vehicle. The apparatus includes an upper grip plate having a generally horizontal first grip portion and a generally vertical first sliding portion extending from a first edge of the first grip portion. The apparatus further includes a lower grip plate which has a generally horizontal second grip portion and a generally vertical second sliding portion extending from a first edge of the second grip portion. Preferably, the grip portions include a lip extending from a second edge opposite to the first edge and extending towards the opposite grip portion. The first and second grip plates are slidably connected such that the distance between the first and second horizontal grip portions is adjustable; a handle is preferably provided to assist in sliding the grip plates. In a particularly preferred embodiment, the first sliding portion includes at least one vertically extending channel into which the second sliding portion extends. A biasing device, such as a spring placed in the vertically extending channel, is biased to reduce the distance between the first and second grip portions. A tubular element, which may be solid, telescoping or a plurality of joinable sections, extends from the upper surface of the first grip portion and a reflective surface, such as a mirror, is attached to the end of the tubular element distal from the first grip portion.

### BRIEF DESCRIPTION OF THE DRAWINGS

A more complete description of the subject matter of the present invention and the advantages thereof, can be achieved by the reference to the following detailed description by which reference is made to the accompanying drawings in which:

FIG. 1 is an exploded perspective view of the grip portion of the preferred embodiment of the present invention;

FIG. 2 is a perspective view of the grip portion of the preferred embodiment of the present invention in the resting or closed orientation;

FIG. 3 is a perspective view of the grip portion of the preferred embodiment of the present invention in the functional or open orientation;

FIG. 4 is an exploded perspective view of the preferred embodiment of the present invention;

FIG. 5 is a perspective view of the preferred embodiment of the present invention; and

FIG. 6 is a side cross-sectional view of the preferred embodiment of the present invention in the installed orientation.

### ELEMENT LIST

12 upper grip plate
14 pole
16 lip
18 first vertical sliding portion
20 channel
22 spring
24 lower grip plate
26 lip
28 second vertical sliding portion
30 grip handle
32 mirror

### DETAILED DESCRIPTION OF THE PREFERRED EMBODIMENT

The following detailed description is of the best presently contemplated mode of carrying out the invention. This description is not to be taken in a limiting sense, but is made merely for the purpose of illustrating general principles of embodiments of the invention.

The instant invention relates to a pivoting, removably secured, trailer hitch assembly having an adjustable mirror such that a vehicle operator may adjust the mirror to easily backup the vehicle to hitch a trailer without the need of direction by a second party.

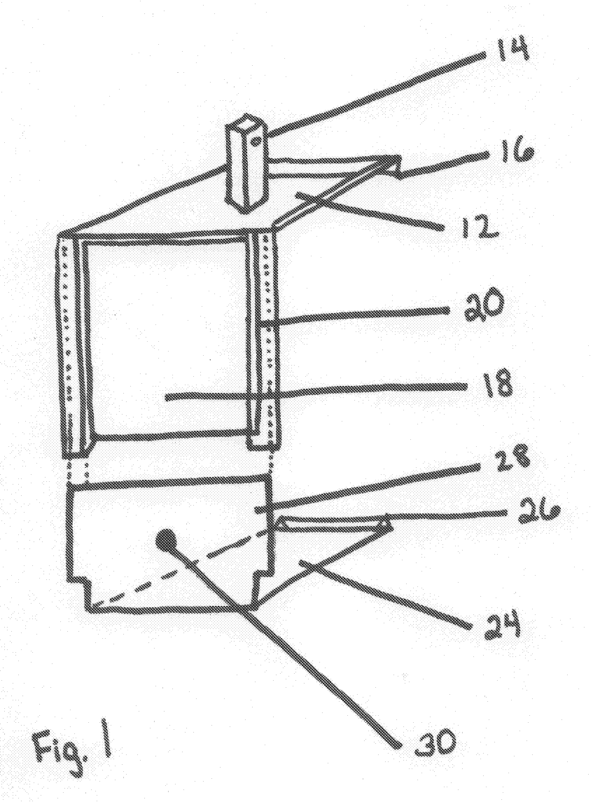

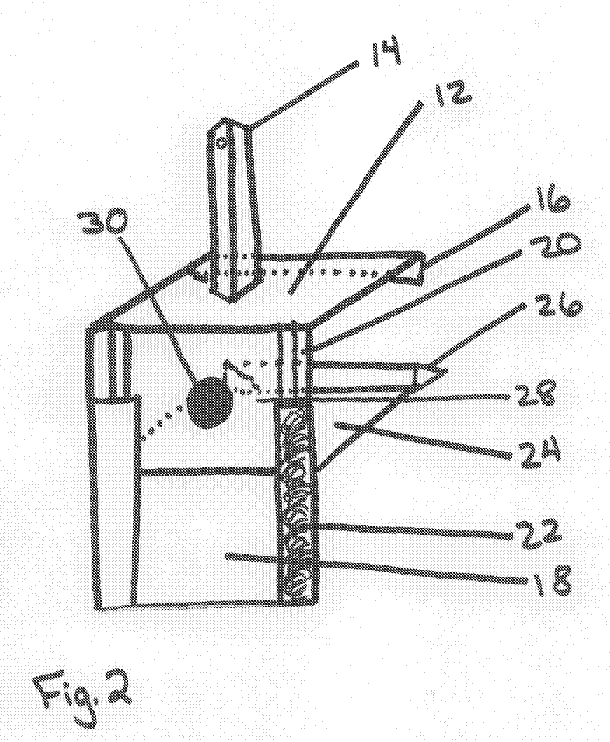

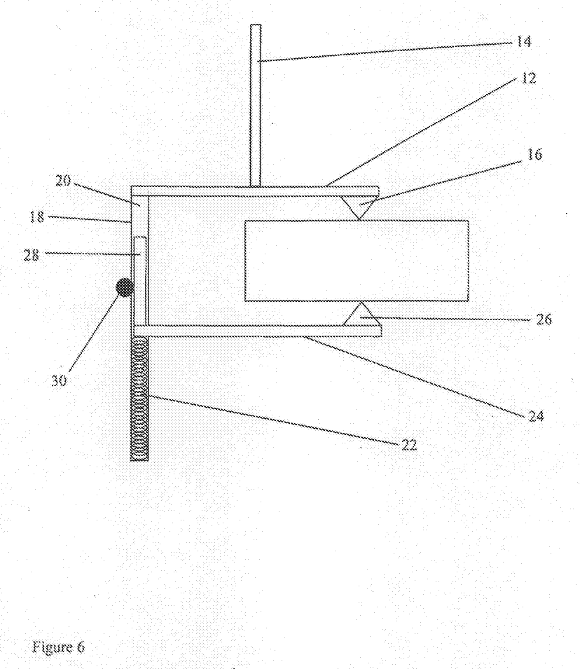

Turning now to the several Figures, where FIG. 1 illustrates an exploded view of the gripping portion of an adjustable trailer hitch alignment device according to the present invention. Extending from the upper grip plate 12 is a hollow pipe 14 which is fixedly attached to the upper grip plate 12. The pipe 14 extends generally perpendicular to the ground when in use while the upper grip plate 12 is generally parallel to the ground in use. One edge of the upper grip plate 12 is preferably constructed with an extension 16 for increasing the gripping capability of the device. An upper vertical sliding portion 18 extends downward from the edge of the upper grip plate which is opposite to the extension 16. In each corner, a channel 20 is provided for maintaining a spring 22 (shown in FIGS. 2-6). The lower grip plate 24 is also generally parallel to the ground in use and includes an extension 26 for increasing the gripping capability of the device along one edge in mirror image to the extension 16 on the upper grip plate 12. A lower vertical sliding portion 28 extends upward from the edge of the lower grip plate 24 which is opposite to the extension 26. This lower vertical sliding portion 28 is constructed to slide within the channels 20 formed in the first vertical sliding portion 18 and is further designed to rest on top of the spring 22 and compress the spring 22 in use. The lower vertical sliding portion 28 preferably includes a knob or handle 30 for sliding the lower grip plate 24 away from the upper grip plate 12 against the bias of the spring 22.

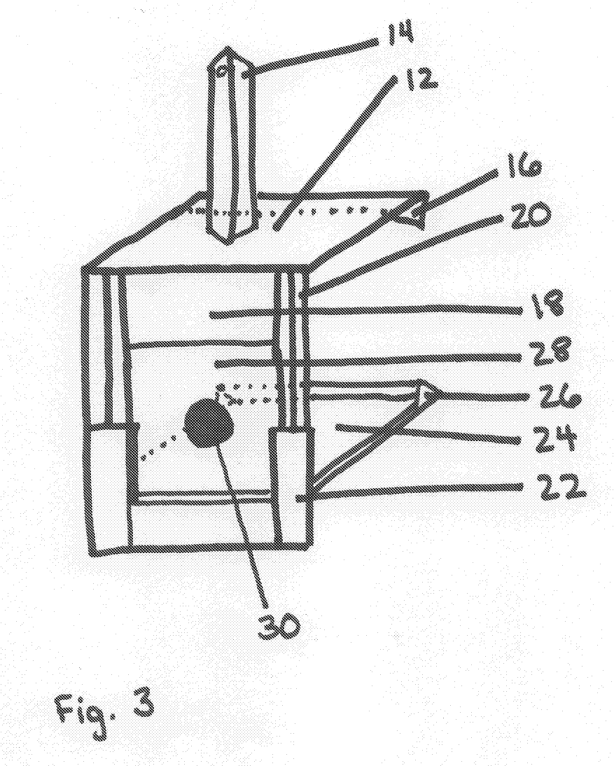

FIGS. 2 and 3 show the gripping portion of the adjustable trailer hitch alignment device. The lower grip plate 24 rests on the spring 22 which is biased to force the upper and lower grip plates 12 and 24 towards each other. Preferably, the spring 22 forces the grip plates 12 and 24 to within about 1½ inches apart and compression of the spring 22 allows the grip plates 12 and 24 to be moved to at least 5 inches apart. FIG. 2 shows the lower grip plate in its resting position with the spring 22 in the uncompressed orientation. The spring 22 biases the lower grip plate 24 toward the upper grip plate 12. FIG. 3 shows the gripping portion of the invention in its open or functional orientation. In this orientation, the lower grip plate 24 is forced downward, preferably by use of a handle 30 attached to the second vertical sliding portion 28 against the bias of the spring 22. This increases the distance between the grip plates 12 and 24 such that the device can grip a portion of a trailer.

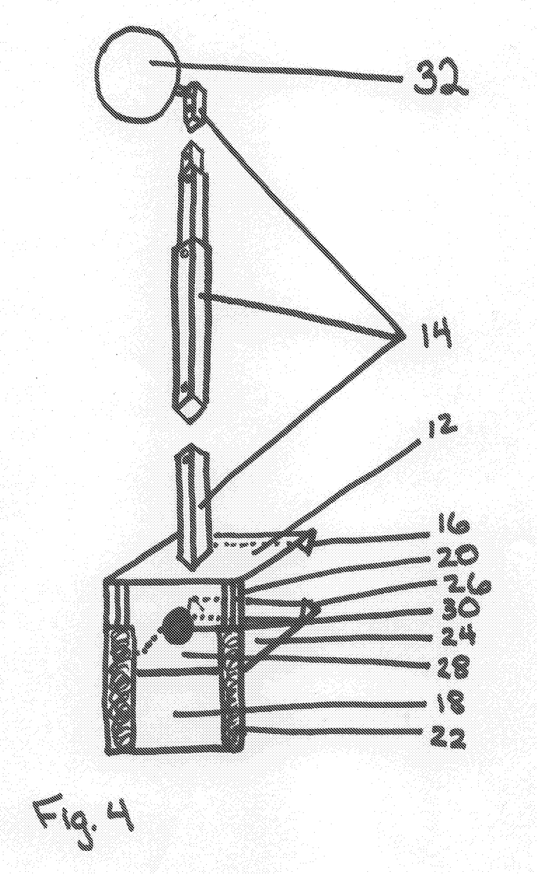

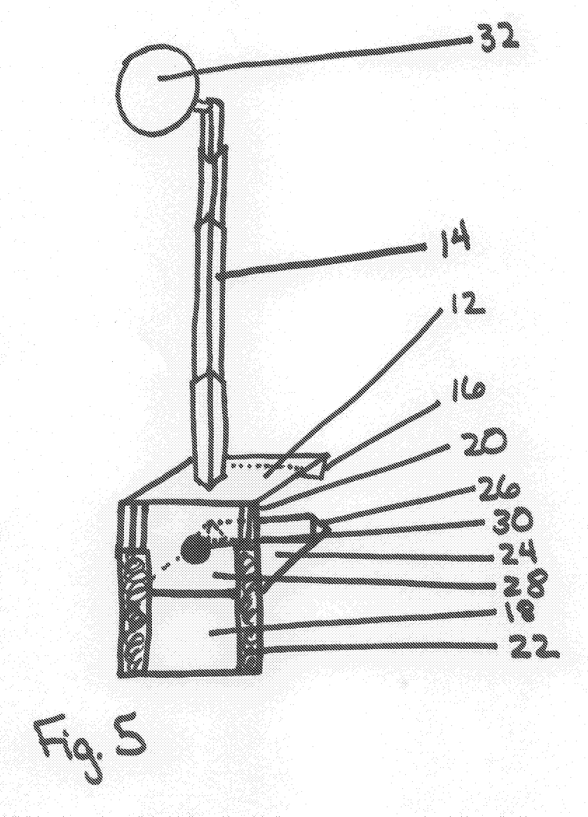

FIGS. 4 and 5 show the preferred embodiment of the present invention. In the most preferred assembly, at the upper end of the pipe 14 is an eight inch convex mirror 32 with a stainless steel swivel stud which is one and ½ inches long connected to the rear surface of the mirror 32. Extending from the swivel stud is a three inch long sleeve with an inside diameter of ¾ inch. A portion of the pipe 14 is adapted with a spring loaded ball bearing fits within this sleeve. This portion of the pipe 14 is about nine inches long and has an internal diameter of ½ inch at the top and 9/16 inch at the bottom. A second portion of the pipe 14 accepts the first portion of the pipe. The second portion of the pipe 14 measures eleven inches in length and has an inner diameter of ⅝ inch. A third portion of the pipe 14 measures fifteen ¾ inches long and fits into the portion of the pipe 14 which extends from the upper surface of the upper grip plate 12 of the device and is two ½ inches long and ¾ inch in diameter. Each of the portions of the pipe 14 includes a spring loaded ball bearing for connecting to the other portions of the pipe 14 at a desired location. At its full extension, the telescoping pipe 14 portions measures forty-seven ½ inches. The gripping portion of the device is as described previously with the upper and lower grip plates measuring five inches wide by four ½ inches deep. At the forward edge of each gripping surface is a ⅛ inch lip 16 and 26 extending toward the opposite grip plate.

Obviously, many modifications may be made without departing from the basic spirit of the present invention. Accordingly, it will be appreciated by those skilled in the art that within the scope of the appended claims, the inventions may be practiced other than has been specifically described herein. Many improvements, modifications, and additions will be apparent to the skilled artisan without departing from the spirit and scope of the present invention as described herein and defined in the following claims.

What is claimed is:

1. A hitch assist apparatus for use with a trailer to be hitched to a towing vehicle wherein the apparatus comprises:
an upper grip plate which comprises a generally horizontal first grip portion and a generally vertical first sliding portion extending from a first edge of the first grip portion;
a lower grip plate which comprises a generally horizontal second grip portion and a generally vertical second sliding portion extending from a first edge of the second grip portion wherein the first and second grip portions are slidably connected such that the distance between the first and second horizontal grip portions is adjustable;
a biasing device which is biased to reduce the distance between the first and second grip portions;
a tubular element extending from the upper surface of the first grip portion;
a reflective surface which is removably attached to the portion of the tubular element distal from the first grip portion.

2. The hitch assist apparatus as set forth in claim 1 wherein the first grip plate includes a lip extending from a second edge opposite to the first edge and extending towards the second grip plate.

3. The hitch assist apparatus as set forth in claim 1 wherein the second grip plate includes a lip extending from a second edge opposite to the first edge and extending towards the first grip plate.

4. The hitch assist apparatus as set forth in claim 1 wherein the first sliding portion includes at least one vertically extending channel into which the second sliding portion extends.

5. The hitch assist apparatus as set forth in claim 1 wherein the biasing device is a spring.

6. The hitch assist apparatus as set forth in claim 4 wherein the biasing device is a spring placed within the at least one vertically extending channel.

7. The hitch assist apparatus as set forth in claim 1 further comprising a handle for increasing the distance between the first and second sliding portions.

8. The hitch assist apparatus as set forth in claim 7 wherein the handle is affixed to the second sliding portion.

9. The hitch assist apparatus as set forth in claim 1 wherein the tubular element is comprised of a plurality of telescoping portions.

10. The hitch assist apparatus as set forth in claim 1 wherein the reflective surface is a mirror.
